(19) United States
(12) Patent Application Publication
(10) Pub. No.: US 2026/0046484 A1
(43) Pub. Date: Feb. 12, 2026

(54) PRIORITY BASED CHANNEL SELECTION

(71) Applicant: Atmosphere.tv, Austin, TX (US)

(72) Inventors: Jeffrey C. DiTullio, Austin, TX (US); Zachary D. Hobbs, Austin, TX (US); Brent A. Hays, Austin, TX (US); George Wilson, Austin, TX (US)

(21) Appl. No.: 18/800,294

(22) Filed: Aug. 12, 2024

(51) Int. Cl. H04N 21/458; H04N 21/258

(52) U.S. Cl. CPC H04N 21/458; H04N 21/25891

(57) ABSTRACT

Systems and methods are disclosed for implementing a channel selector to automatically control the output of a streaming device based on a prioritized list of content. In certain embodiments, a method may comprise implementing a priority-based channel selector for a streaming device, including determining a priority list for prioritized content to play at the streaming device, determining a content source device connected to the streaming device, determining content available to the streaming device based on the content source device, and automatically controlling the streaming device to play the prioritized content based on the priority list and the content available, including directing the streaming device to send a control signal to the content source device.

### SUMMARY

In certain embodiments, a method may comprise implementing a priority-based channel selector for a streaming device, including determining a priority list for prioritized content to play at the streaming device, determining a content source device connected to the streaming device, determining content available to the streaming device based on the content source device, and automatically controlling the streaming device to play the prioritized content based on the priority list and the content available, including directing the streaming device to send a control signal to the content source device.

In certain embodiments, a system may comprise a streaming service configured to implement a priority-based channel selector for a streaming device, the streaming service physically remote from the streaming device. The system may determine a priority list for prioritized content to play at the streaming device, determine a content source device connected to the streaming device, determine content available to the streaming device based on the content source device, and automatically control the streaming device to play the prioritized content based on the priority list and the content available, including directing the streaming device to send a control signal to the content source device.

In certain embodiments, a memory device may store instructions that, when executed, cause a processor to perform a method comprising implementing, via a streaming service physically remote from a streaming device, a priority-based channel selector for the streaming device, including determining a priority list for prioritized content to play at the streaming device, determining a content source device connected to the streaming device based on receiving information on the content source device from the streaming device, determining content available to the streaming device based on the content source device, and automatically controlling the streaming device to play the prioritized content based on the priority list and the content available, including directing the streaming device to send a control signal to the content source device.

### BRIEF DESCRIPTION OF THE DRAWINGS

FIG. 1 is a diagram of a system configured to implement priority-based channel selection, in accordance with certain embodiments of the present disclosure;

FIG. 2 is a process flow diagram of a system configured to implement priority-based channel selection, in accordance with certain embodiments of the present disclosure;

FIG. 3 depicts a flowchart of an example method for implementing priority-based channel selection, in accordance with certain embodiments of the present disclosure; and

FIG. 4 is a diagram of a system configured to implement priority-based channel selection, in accordance with certain embodiments of the present disclosure.

### DETAILED DESCRIPTION

In the following detailed description of certain embodiments, reference is made to the accompanying drawings which form a part hereof, and in which are shown by way of illustration of example embodiments. It is also to be understood that features of the embodiments and examples herein can be combined, exchanged, or removed, other embodiments may be utilized or created, and structural changes may be made without departing from the scope of the present disclosure.

In accordance with various embodiments, the methods and functions described herein may be implemented as one or more software programs running on a computer processor or controller. Dedicated hardware implementations including, but not limited to, application specific integrated circuits, programmable logic arrays, and other hardware devices can likewise be constructed to implement the methods and functions described herein. Methods and functions may be performed by modules or nodes, which may include one or more physical components of a computing device (e.g., logic, circuits, processors, etc.) configured to perform a particular task or job, or may include instructions that, when executed, can cause a processor to perform a particular task or job, or any combination thereof. Further, the methods described herein may be implemented as a physical device, such as a computer readable storage medium or memory device, including instructions that, when executed, cause a processor to perform the methods.

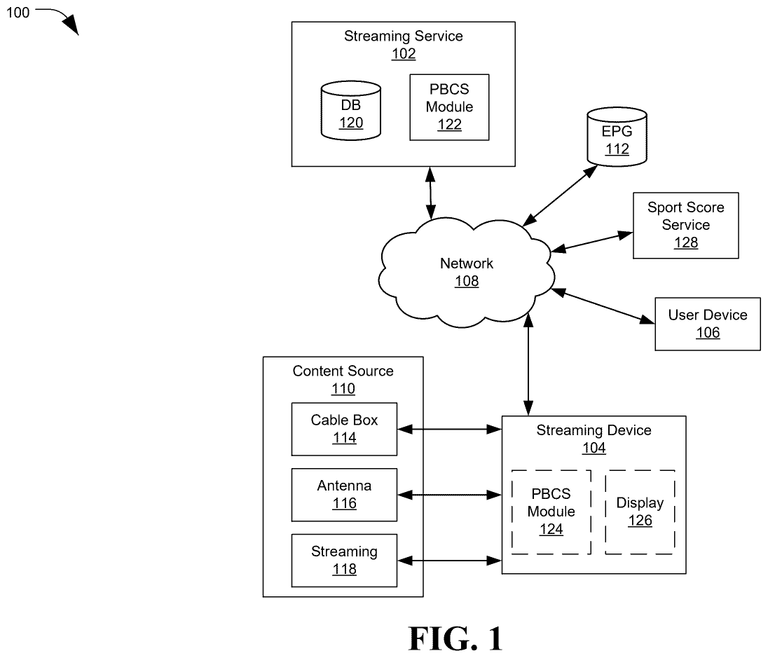

FIG. 1 depicts a diagram of a system 100 configured to implement priority-based channel selection, in accordance with certain embodiments of the present disclosure. The system 100 may include a streaming service 102, a streaming device 104, a user device 106, a content source 110, an electronic program guide (EPG) 112, a sport score service 128, and a network 108 over which the components of system 100 may communicate and exchange data. Each or any of streaming service 102, streaming device 104, user device 106, content source 110, EPG 112, sport score service 128, and network 108 may be implemented via computers, servers, hardware and software modules, or other system components.

Streaming service 102 may offer a variety of content to consumers, such as various channels and genres or types of video, sports, television programming, movies, and more. However, content rights and availability have become fragmented across various services, platforms, and delivery mediums. Desirable content may be spread across multiple channels, different video on demand (VOD) streaming services, cable providers, antenna broadcasts, satellite, over the top (OTT) internet television service, and other sources. For example, sports broadcast rights may be dispersed so that viewers cannot watch all games or matches with a single package, and may need to utilize several media sources. A user may be required to regularly switch channels or even viewing platforms or sources to watch the content they want to see, and keeping track of what content is available where may become burdensome.

The problem may be exacerbated when a user must utilize multiple different input sources or devices to access desired content on their television or other viewing device, which may require active user intervention to toggle between television input sources, and then navigate through multiple channels or menus of the input device to reach desired content. Of particular note may be televisions or screens showing at public venues, such as restaurants, bars, lounges, or similar locations. Employees may need to monitor what is playing on the screens, and then locate and utilize remote controls or other input apparatus to switch to a different input, and potentially require other remotes to control the attached input devices. A user or business may miss content they wish to see or display because they were unaware the content was on another channel, because they lost track of time on when to change the channel, or because it was too burdensome to stop what they were doing and change the channel. Businesses may prefer to just set televisions up with a single input device and channel, rather than monitoring and changing input or channel settings. To address these issues, system 100 provides an implementation for priority-based channel selection (PBCS).

Streaming service 102 may support, control, or maintain streaming device 104. For example, streaming service 102 may publish, update, or maintain software or firmware modules to enable the operation of streaming device 104, and enable continued interoperability between streaming device 104 and other devices to which streaming device 104 may connect and interact. In some examples, streaming service 102 may generate, publish, or broadcast streaming content to streaming device 104. Some or all of the content, such as live content, video segments, or advertisements, may be obtained or transmitted from other content providers (not shown), for example based on distribution licensing agreements. In some embodiments, the streaming service 102 may acquire (e.g., download) content from the other content providers and generate streaming content to send to streaming device 104 over network 108. The streaming service 102 may provide a plurality of content feed options, such as multiple channels or content categories. Streaming service 102 may be configured with the capability to adjust or change behavior at the streaming device 104 (e.g., through commands sent via network 108) to change the channel or content feed displaying at the streaming device 104, adjust the volume or display settings, or otherwise modify the content being presented at streaming device 104.

Further, streaming service 102 may include one or more data storage devices, data storage mediums, data storage servers, and related data structures, collectively referred to as database (DB) 120. DB 120 may store information about streaming device 104 or associated client systems or accounts, streaming content data, or other information. For example, DB 120 may store a unique device identifier of streaming device 104, and demographic or attribute information associated with the streaming device, such as a type of account, a geographic location of the streaming device, and a type of venue in which the device is situated (e.g., a private home, or a public restaurant, sports bar, activity center, or other location). In some embodiments, the attribute information may include a history of content viewed at streaming device 104, user viewing or content preferences, and user-or automatically-generated content priority lists, according to embodiments discussed herein.

Streaming device 104, such as computers, smartphones, set-top boxes, or televisions, may receive video content feeds, such as video on demand (VOD), live broadcasts, or other streaming content. A computing device running a streaming device application (app) or module may convert the computing device into a special purpose streaming device 104 capable of operating as described herein. Streaming device 104 may include or be connected to a display 126, which may be a television, monitor, screen, digital billboard, computer, smartphone, or other device having a digital display element.

Streaming device 104 may receive live or pre-recorded streamed content over network 108, such as from streaming service 102 or other sources, and perform any data conversion necessary to display the streaming content on display device 126. In some examples, a business may connect streaming device 104 to a television or video display device 126 at the business location (e.g., at a bar or restaurant) for the entertainment of customers. Streaming content may include both video segments and advertisements, as well as supplemental overlay data, such as news tickers, sports scores, stock market updates, a listing of current or upcoming video segments or programming, or other data. Further, the streaming device 104 may also generate or display a dashboard, home screen, or other menu or navigation screen on the display 126 via which a user may select content sources or channels to play.

Streaming device 104 may be configured to be controlled via one or more local control options, such as a physical remote control, control elements on the streaming device itself, or other local inputs. As used herein, local controls or local inputs may include control devices physically proximate to the streaming device 104, which may send inputs from the control device to the streaming device 104 via wired electrical connections, infrared signals, Bluetooth, local Wi-Fi, radio frequency, or other limited-range transmission options. Streaming device 104 may also be controlled remotely, for example based on control commands from streaming service 102, user device 106 (e.g., via a web-based interface over Wi-Fi), or other means.

Instead of or in addition to receiving media content over network 108, streaming device 104 may also be connected to or receive media content from one or more other content sources 110. Content sources 110 may include devices that may plug into streaming device 104 (e.g., via HDMI cables, coaxial cables, or other physical or wired connections), or connect to streaming device 104 via local Wi-Fi, Bluetooth, or other close- or limited-range wireless transmission options. Content source 110 may include a cable box 114, satellite television box, or other broadcast feed device. Another example content source may include an antenna 116 (e.g., digital or analog) for receiving local broadcast transmissions. Content sources 110 may also include a streaming box 118, such as a set-top box or dongle that provides internet streaming content. In some examples, one or multiple of content sources 110 may each provide multiple channels of content. Content sources 110 may provide content for display on display screen 126, for example via plugging into streaming device 104, which is itself connected to display 126.

Electronic program guides (EPGs) for one or more of the content sources 110 may be stored to a database or other data source 112. EPGs 112 may include data on programming or content schedules available via the various content sources 110, such as what shows, movies, sporting events, or other media is available from the content sources 110, and on what channel and at what time. The EPGs 112 may provide current and upcoming schedules, and may be updated continually or periodically.

EPGs 112 may provide a schedule of when content is expected to begin or end, but in some examples the content may not begin or end at the expected times. For example, sporting events may end early or run long, depending on the progress of the event, and this can impact not only the sporting event itself, but content scheduled to follow the sporting event. Sport score service 128 may be a data source providing live updates on sporting events. The live updates may be used to determine when a broadcast sporting event has actually ended, and may be more reliable than the EPGs 112. For example, an online service may provide live sports scores, and may indicate when a score is “final”, indicating that the event has ended. Accordingly, the sport score service 128 may be used to determine whether broadcast sporting events are still ongoing or have ended. The sport score service 128 may be accessed via network 108, such as through a website interface, an application programming interface (API), or other interface.

User device 106 may include a computing device such as a smartphone, tablet, laptop, or other personal computing system. A user may access or change settings for streaming device 104 via user device 106, for example by accessing streaming device 104 or streaming service 102 via network 108. In an example, user device 106 may be used to select programming or content to display via streaming device 104. The content may be selected to play immediately, or a user may designate prioritized content lists or tiers that may be used to control the output of streaming device 104 over time.

In order to implement a priority-based channel selection system as described herein, streaming service 102 may be equipped with a PBCS module 122, streaming device 104 may be equipped with PBCS module 124, or both. For ease of explanation, operation of a PBCS module will be provided in reference to PBCS module 122 at streaming service 102 unless otherwise specified, although the described operations may also apply to PBCS module 124.

PBCS module 122 may interface with and exchange messaging with streaming device 104. When a content source 110 is connected to streaming device 104, the streaming device 104 may determine what the content source device is, for example via extended display identification data (EDID) shared between the content source and the streaming device 104 over an HDMI input port. The streaming device 104 may share details of the attached content source 110 devices to streaming service 102 (e.g., to PBCS module 122), so that streaming service 102 may monitor what content sources are available to which streaming device 104. The streaming service 102 may use the identified content sources 110 to look up or access EPG data 112, sport score service data 128, or other content information for the channels or content available from each content source 110. Streaming service 102 or streaming device 104 may update a user interface (UI) dashboard or home screen to add each content source 110 or its associated content as a tile on the dashboard. By adding the content sources 110 to the streaming device 104 dashboard, a user may be able to access all available content for streaming device 104 via a single unified interface, without the need to change device inputs.

The PBCS module 122 may be configured to implement priority-based channel selection to control the play of content at streaming device 104. Using a hierarchical list of prioritized content, the PBCS module 122 may evaluate available content from streaming service 102 or any other content source 110 connected to streaming device 104, and control the streaming device 104 to play the most-prioritized available content.

The tier list may include variably specific categories of content. For example, a tier list may be categorized so that Virginia Tech football games have highest priority, followed by any other Virginia Tech sporting event, followed by any NCAA sporting event, followed by any baseball game. Different priority tier lists may be specified per time period (e.g., different days of the week may have different tier lists), and may be different per streaming device 104 (e.g., sports bars may have multiple televisions, each of which may focus on a different type of sport). The priority tier list may be generated or submitted by a user, such as via a user device 106 or streaming device 104 accessing a web front-end or app user interface (UI) for the streaming service 102. In another example, the priority tier list may be generated by an operator or administrator for streaming service 102, such as based on preferences indicated by a customer of streaming device 104 (e.g., family-friendly programming, or trivia programming on Thursday nights), information about a venue where streaming device 104 is located (e.g., sports programming for a sports bar), or other information. In some embodiments, the streaming service 102 may monitor viewing habits or trends at streaming device 104, and store viewing history data to database 120. Based on the viewing history, a machine learning model (e.g., an artificial intelligence algorithm or AI) may automatically generate a content priority list to apply at streaming device 104. For example, if streaming device 104 is always set to play Sunday night football and a comedy show block on Thursdays, an automatic priority list generating algorithm of the streaming service 102 may create a tier list that automatically sets the streaming device 104 prioritize Sunday night football sports events on Sunday night, and to prioritize comedy shows on Thursdays, without a user being required to manually change the input and channel.

The streaming service 102 may be configured to access and utilize EPG 112 and sport score service 128 for implementing the prioritized content list. For example, EPGs 112 may be provided for various channels of streaming service 102 or content sources 110, and a user or administrator may use the EPGs 112 to select categories of content to add to a prioritized list. Similarly, a priority list generation algorithm of streaming service 102 may utilize the EPGs 112 to determine patterns or preferences in viewing history of what a streaming device 104 is set to display, along with user-specified interests, demographics information, or other data, in order to generate a prioritized list. The streaming service 102 may monitor the EPGs 112 for what content is playing, and compare it against the prioritized list. If available content is found that has a higher priority than what is currently playing on streaming device 104, the streaming service 102 may control the streaming device to change the input and channel to display the prioritized content. Further, streaming service 102 may monitor sport score service 128 to determine whether a sporting event currently playing on streaming device 104 has ended or is running long, in order to potentially change to another content stream. The streaming service 102 may continue to monitor the EPGs 112 in order to determine if an even higher priority content stream has begun, in order to make sure the highest-priority content is playing. Alternately, the streaming service 102 or PBCS module 122 may be configured to not interrupt a piece of content in the middle, so as to not disrupt viewers of a sporting event or show. If no more prioritized content is available, the streaming service may return the streaming device 104 to a channel or input that was playing before the channel was changed to the priority content, or may leave the streaming device 104 on the most recent channel. If the previous channel was a video on demand (VOD) stream, the streaming service 102 may cause the streaming device 104 to resume the stream where it left off.

Based on identified prioritized content, streaming service 102 may send control signals (e.g., via network 108) to streaming device 104 to change the channel, input, or both, in order to play the prioritized content from the corresponding content source 110. Based on the received signals, the streaming device 104 may generate control commands to control the output of the corresponding content source 110 device. For example, streaming device 104 may generate consumer electronic control (CEC) signals or commands, and transmit them over an HDMI connection to, e.g., cable box 114 or streaming box 118.

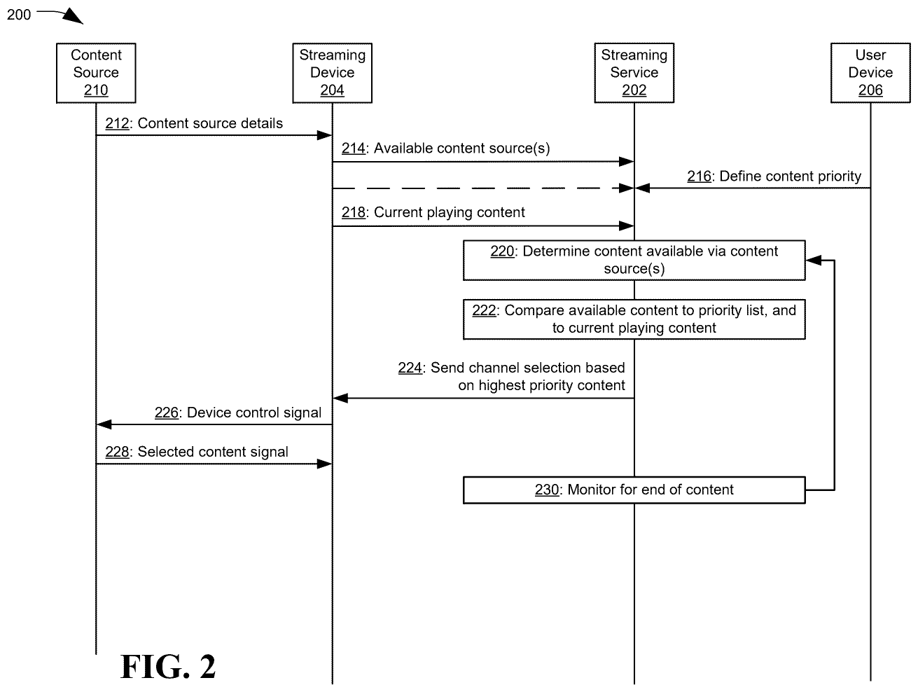

In this manner, a display 126 at a home or venue may be configured to automatically switch to preferred content, from any number of content sources 110, without any in-the-moment human intervention. This may alleviate the issues of keeping track of when desired content is playing, of having multiple content sources 110 attached to a display 126, of having to manually switch channels, and of having to monitor the display 126 to keep desired content playing. An example process flow for a priority-based channel selection system is described in regard to FIG. 2.

FIG. 2 is an example process flow diagram of a system 200 configured to implement priority-based channel selection, in accordance with certain embodiments of the present disclosure. FIG. 2 depicts a sequence of operations and data transfers between a content source 210, a streaming device 204, a streaming server 202, and a user device 206, which may correspond to content source 110, a streaming device 104, a streaming service 102, and a user device 106 of FIG. 1, respectively. Although not shown in FIG. 2 for the sake of clarity, information may also be exchanged between elements of system 200 and other elements of FIG. 1, such as EPG 112 and sport score service 128. In particular, the operations of FIG. 2 may be a process for establishing a content priority list or hierarchy, determining available content from content sources 210 connected to a streaming device 204, and automatically controlling the streaming device to switch inputs, channels, or both in order to play prioritized content.

The method may include providing content source details from content source 210 to streaming device 204, at 212. Content source details may include information such as a type of content source device 210, display and operational characteristics of content provided from the content source 210, and an indication of the capabilities of the content source 210. In an example embodiment, the content source details may be provided via EDID information provided or exchanged when content source 210 is connected to streaming device 204 via an HDMI cable. In some examples, content source details may also include program content available via the content source 210, or an indication of how or where to access available content or an EPG for the content source 210.

At 214, the method may include the streaming device 204 providing the streaming service 202 with information on the available content sources 210, as received via the content source details 212.

At 216, content priority may be defined at the streaming service 202 from user device 206, or from streaming device 204. In some examples, a user may utilize user device 206 to access a web or app interface of streaming service 202, in order to manually identify prioritized content, and the hierarchy of how the identified content should be prioritized. In another example, streaming service 202 may monitor the viewing history, demographic information, or other details of streaming device 204, and automatically generate a priority list based on the information. In some examples, an operator or administrator of streaming service 202 may create a content priority list for streaming device 204, or may update or modify an automatically generated priority list.

At 218, streaming service 202 may receive an indication of content that is currently playing at streaming device 204. For example, the streaming device 204 may send an indication of what content source 210 the streaming device is set to, what channel, or even a particular piece of media. Streaming service 202 may use EPGs or other data sources to attempt to identify the content playing, if such content was not specifically identified by the streaming device 204. In some examples, streaming device 204 may not identify its current playing content to streaming service 202, or streaming service 202 may only identify the content if the streaming device 204 is tuned to a channel provided by the streaming service.

At 220, streaming service 202 may determine content available via the content source(s) 210, such as by using EPGs, sport score services, or other available content identifying information. The streaming service 202 may compare the available content to the content priority list for the streaming device 204, and in some examples to the current playing content at the streaming device, at 222. As part of the comparison, the streaming service 202 may identify whether any content specified in the content priority list is currently available to view at the streaming device 204, and may identify the highest-priority content available. This may include determining whether content available on another channel or content source 210 is ranked higher in the priority list than the currently playing content.

At 224, the streaming service 202 may send a content source or channel selection identifier or command to streaming device 204 based on the identified highest priority content. The identifier or command may direct or control the streaming device 204 to change its content source (e.g., input port), channel, or both to the identified priority content. In response, the streaming device 204 In response to the content selection information from the streaming service 202, the streaming device 204 may send a device control signal to the appropriate content source 210, at 226. For example, the streaming device 204 may employ CEC signals over an HDMI connection to control a content source device 210 to change to a particular channel or content feed. In response, the content source 210 may provide the selected content signal to the streaming device 204, at 228, which may display the content on a screen or television. The streaming service 202 may continue to monitor for higher-priority content available and send channel selection signals based on the priority list, at 224, and change the content source and channel at streaming device 204 as appropriate.

At 230, the streaming server 202 may monitor for an end of the currently playing content. Monitoring for the end of a content item may include reviewing EPGs for the content source 210, or other data sources such as live sports feeds from a sport score service, to determine whether content on the schedule is expected to end earlier or later than expected. For example, after a score for a sporting event is reported as “final” from a live score tracker, the streaming service 202 may wait for a selected period (e.g., ten minutes) for final reporting on the sporting event, and then consider or implement a channel change.

Once the content has ended, the streaming service may return to determining the content available via content source(s) 210, at 220, and comparing the available content to the content priority list, at 222. If content from the priority list is available, the streaming service 202 may direct the streaming device to play the content, at 224-228. If no content from the priority list is currently available, the streaming service 202 may leave the streaming device 204 on the current channel. In some embodiments, streaming service 202 may keep a log of what channel or content the streaming device was currently playing before the channel was automatically changed (e.g., at step 218), and may direct the streaming device 204 to return to that channel or content. For example, if VOD media was playing before a priority sporting event came on, the streaming service 202 may direct the streaming device 204 to resume the VOD media once the sporting event ends.

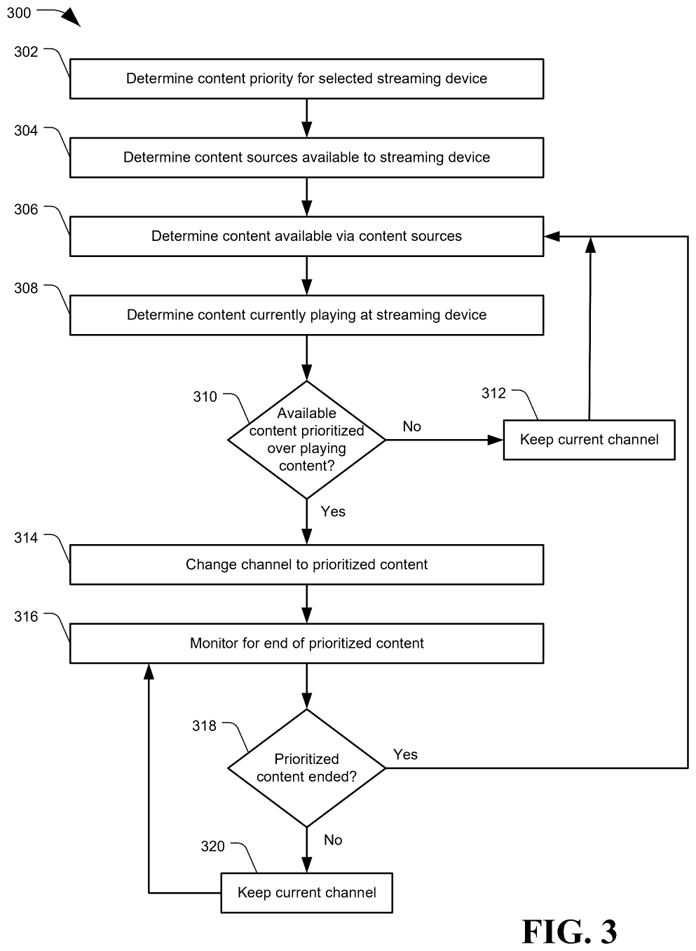

It may be noted that a user may override a priority-based automated content change at any time by manually changing a channel or content source at the streaming device 204. Based on default or configured settings, the streaming device 204 may continue to monitor the priority list and available content, and change the content when priority content is identified, or the streaming device may turn off the automated channel selection feature in response to a user taking over control. Other embodiments are also possible. An example system configured to implement priority-based channel selection is described in regard to FIG. 3.

FIG. 3 depicts a flowchart 300 of an example method for implementing priority-based channel selection, in accordance with certain embodiments of the present disclosure. In particular, FIG. 3 presents an example method of identifying available content sources and associated content for a streaming device, identifying priority content for the streaming device, and automatically setting the streaming device to change to the priority content. The method may be implemented by a priority-based channel selection module, such as module 122 at streaming service 102 or module 124 at streaming device 104 of FIG. 1.

At 302, the method may include determining content priority for a selected streaming device. Content priority may be established via a list or hierarchy of specific content elements, content categories, genres, or other content elements (e.g., football games, music videos, comedy movies, etc.). Content priority may be established via direct user input or selection, automatically generated based on demographics associated with the streaming device, viewing history, or other details, set by an administrator of a streaming service associated with the streaming device, by other means, or by any combination thereof.

At 304, the method may include determining content sources available to the streaming device. Content may be available to the device from a variety of sources, such as a streaming service associated with the device itself (e.g., directly over the internet), or may be provided via other devices connected to the streaming device (e.g., cable or satellite television boxes, digital antennas, streaming box-top sets or dongles, or other content sources). When a content source device is connected to the streaming device, extended display identification data (EDID) or similar source-identifying information may be shared between the content source and the streaming device 104 over an HDMI or other input port. The exchanged identifying information may provide information on the content available from the content source, or may provide enough detail to enable an electronic programming guide (EPG) or other content directory to be identified and accessed for the content source. Using the EPG or other content director, the method may include determining the content available via the content sources, at 306. The method may also include determining the content currently playing at the streaming device, at 308.

At 310, the method may include determining whether any of the content available from the content sources is prioritized over the currently playing content. If not, the method may include keeping the current channel, at 312, and continuing to determine available content at 306 and comparing it's priority to the current content, at 310.

If a piece of currently available content is prioritized over the currently playing content, the method may include changing the channel at the streaming device to the prioritized content, at 314. The available content having the highest priority list slot or ranking may be selected over lower-priority available content.

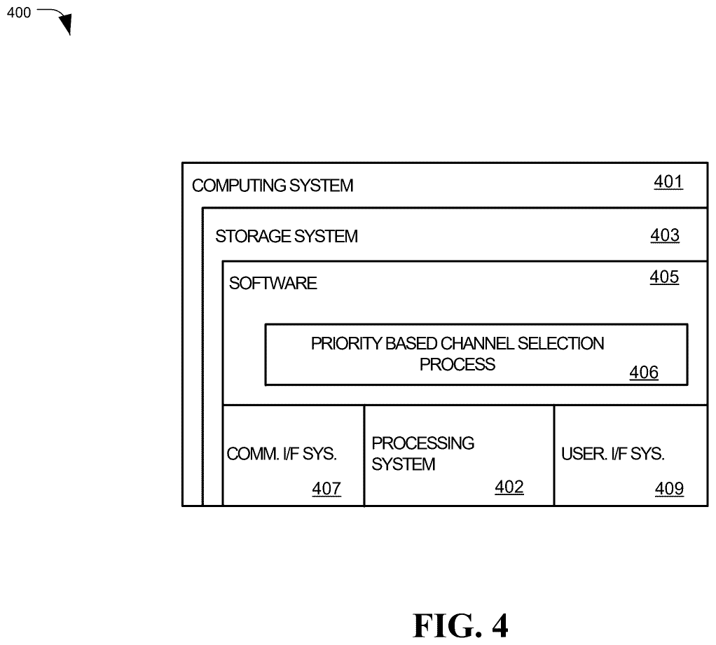

At 316, the method may include monitoring for the end of the prioritized content. This may involve monitoring for when the content block ends on an EPG, monitoring for an end-of-game sport score via a live score monitoring service, or using other available data sources. At 318, a determination may be made whether the prioritized content has ended. If not, the method may include keeping the streaming device on the current channel, at 320, and continuing to monitor for the end of the prioritized content, at 316. If the prioritized content has ended, the method may include determining content currently available via the content sources, at 306, and selecting a new prioritized content to display, at 310. Alternately, the method may include returning the streaming device to content being played prior to switching to the prioritized content, or leaving the streaming device on the current content source or channel. An example system configured to implement priority-based channel selection is described in regard to FIG. 4.

FIG. 4 is a diagram of an example system 400 configured to implement priority-based channel selection, in accordance with certain embodiments of the present disclosure. System 400 may be an example of an apparatus including a computing system 401 that is representative of any system or collection of systems in which the various processes, systems, programs, services, and scenarios disclosed herein may be implemented. For example, computing system 401 may be an example of streaming service or server 102, streaming device 104, user device 106, content sources 110, EPGs 112, sport score service 128, network 108, or any of the subcomponents depicted in system 100 of FIG. 1. Examples of computing system 401 include, but are not limited to, set top boxes, smart televisions, server computers, desktop computers, laptop computers, smart devices, routers, switches, web servers, cloud computing platforms, and data center equipment, as well as any other type of physical or virtual server machine, physical or virtual router, cloud containerized application, and any variation or combination thereof.

Computing system 401 may be implemented as a single apparatus, system, or device or may be implemented in a distributed manner as multiple apparatuses, systems, or devices. Computing system 401 may include, but is not limited to, processing system 402, storage system 403, software 405, communication interface system 407, and user interface system 409. Processing system 402 may be operatively coupled with storage system 403, communication interface system 407, and user interface system 409.

Processing system 402 may load and execute software 405 from storage system 403. Software 405 may include and implement priority based channel selection process 406, which may be representative of any of the operations for determining a priority list for content to display at a streaming device, determining available content sources for the streaming device, determining content available from the content sources, comparing the available content to the priority list, and changing the channel or content source at the streaming device to display the prioritized content, as discussed with respect to the preceding figures. When executed by processing system 402, software 405 may direct processing system 402 to operate as described herein for at least the various processes, operational scenarios, and sequences discussed in the foregoing implementations. Computing system 401 may optionally include additional devices, features, or functionality not discussed for purposes of brevity.

In some embodiments, processing system 402 may comprise a micro-processor and other circuitry that retrieves and executes software 405 from storage system 403. Processing system 402 may be implemented within a single processing device but may also be distributed across multiple processing devices or sub-systems that cooperate in executing program instructions. Examples of processing system 402 may include general purpose central processing units, graphical processing units, application specific processors, and logic devices, as well as any other type of processing device, combinations, or variations thereof.

Storage system 403 may comprise any memory device or computer readable storage media readable by processing system 402 and capable of storing software 405. Storage system 403 may include volatile and nonvolatile, removable and non-removable media implemented in any method or technology for storage of information, such as computer readable instructions, data structures, program modules, or other data. Examples of storage media include random access memory, read only memory, magnetic disks, optical disks, optical media, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 403 may also include computer readable communication media over which at least some of software 405 may be communicated internally or externally. Storage system 403 may be implemented as a single storage device but may also be implemented across multiple storage devices or sub-systems co-located or distributed relative to each other. Storage system 403 may comprise additional elements, such as a controller, capable of communicating with processing system 402 or possibly other systems.

Software 405 (including priority based channel selection process 406 among other functions) may be implemented in program instructions that may, when executed by processing system 402, direct processing system 402 to operate as described with respect to the various operational scenarios, sequences, and processes illustrated herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 405 may include additional processes, programs, or components, such as operating system software, virtualization software, or other application software. Software 405 may also comprise firmware or some other form of machine-readable processing instructions executable by processing system 402.

In general, software 405 may, when loaded into processing system 402 and executed, transform a suitable apparatus, system, or device (of which computing system 401 is representative) overall from a general-purpose computing system into a special-purpose computing system as described herein. Indeed, encoding software 405 on storage system 403 may transform the physical structure of storage system 403. The specific transformation of the physical structure may depend on various factors in different implementations of this description. Examples of such factors may include, but are not limited to, the technology used to implement the storage media of storage system 403 and whether the computer-storage media are characterized as primary or secondary storage, as well as other factors.

For example, if the computer readable storage media are implemented as semiconductor-based memory, software 405 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 407 may include communication connections and devices that allow for communication with other computing systems (not shown) over communication networks (not shown). Examples of connections and devices that together allow for inter-system communication may include network interface cards, antennas, power amplifiers, radio-frequency (RF) circuitry, transceivers, and other communication circuitry. The connections and devices may communicate over communication media to exchange communications with other computing systems or networks of systems, such as metal, glass, air, or any other suitable communication media.

Communication between computing system 401 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Moreover, although specific embodiments have been illustrated and described herein, it should be appreciated that any subsequent arrangement designed to achieve the same or similar purpose may be substituted for the specific embodiments shown.

This disclosure is intended to cover any and all subsequent adaptations or variations of various embodiments. Combinations of the above embodiments, and other embodiments not specifically described herein, will be apparent to those of skill in the art upon reviewing the description. Steps depicted in the flowcharts may optionally be excluded, added, performed in a different order, or performed with different degrees of concurrency than shown (e.g., steps depicted as sequential may be performed concurrently). Additionally, the illustrations are merely representational and may not be drawn to scale. Certain proportions within the illustrations may be exaggerated, while other proportions may be reduced. Accordingly, the disclosure and the figures are to be regarded as illustrative and not restrictive.

What is claimed is:

1. A method comprising:
implementing a priority-based channel selector for a streaming device, including:
determining a priority list for prioritized content to play at the streaming device;
determining a content source device connected to the streaming device;
determining content available to the streaming device based on the content source device; and
automatically controlling the streaming device to play the prioritized content based on the priority list and the content available, including directing the streaming device to send a control signal to the content source device.

2. The method of claim 1 further comprising:
implementing the priority-based channel selector at a streaming server remote from the streaming device, including:
determining the content source device based on receiving information on the content source device from the streaming device.

3. The method of claim 2 further comprising:
providing streaming content from the streaming server to the streaming device; and
determining the content available to the streaming device, including first content from the content source device and the streaming content from the streaming server.

4. The method of claim 3 wherein:
the content source device is one of a plurality of content source devices connected to the streaming device;
the method further comprises:
determining the content available to the streaming device based on content available from each of the plurality of content source devices; and
automatically controlling the streaming device to play the prioritized content includes directing the streaming device to switch to an input port corresponding to a selected one of the plurality of content source devices.

5. The method of claim 1 further comprising:
receiving a user selection of programming to add to the prioritized content; and
generating the priority list based on the user selection.

6. The method of claim 1 further comprising:
determining attribute information associated with the streaming device; and
automatically generating the priority list based on the attribute information.

7. The method of claim 1 further comprising:
determining a viewing history associated with the streaming device; and
automatically generating the priority list based on the viewing history.

8. The method of claim 1 further comprising:
determining the content available to the streaming device, including accessing an electronic program guide associated with the content source device.

9. The method of claim 1 further comprising:
monitoring for an end of the prioritized content playing at the streaming device based on a sport score reporting service; and
dynamically changing content playing at the streaming device when the end of the prioritized content is detected.

10. A system comprising:
a streaming service configured to implement a priority-based channel selector for a streaming device, the streaming service physically remote from the streaming device, including:
determine a priority list for prioritized content to play at the streaming device;
determine a content source device connected to the streaming device;
determine content available to the streaming device based on the content source device; and
automatically control the streaming device to play the prioritized content based on the priority list and the content available, including directing the streaming device to send a control signal to the content source device.

11. The system of claim 10, wherein:
the content source device is one of a plurality of content source devices connected to the streaming device;
the streaming service is further configured to:
determine the content available to the streaming device based on content available from each of the plurality of content source devices; and
automatically control the streaming device to play the prioritized content includes directing the streaming device to switch to an input port corresponding to a selected one of the plurality of content source devices.

12. The system of claim 10 comprising the streaming service further configured to:
receive a user selection of programming to add to the prioritized content; and
generate the priority list based on the user selection.

13. The system of claim 10 comprising the streaming service further configured to:
automatically generate the priority list at the streaming service based on attribute information associated with the streaming device.

14. The system of claim 10 comprising the streaming service further configured to:
determine the content available to the streaming device, including accessing an electronic program guide associated with the content source device.

15. The system of claim 10 comprising the streaming service further configured to:
monitor for an end of the prioritized content playing at the streaming device based on a sport score reporting service; and
dynamically change content playing at the streaming device when the end of the prioritized content is detected.

16. A memory device storing instructions that, when executed, cause a processor to perform a method comprising:
implementing, via a streaming service physically remote from a streaming device, a priority-based channel selector for the streaming device, including:
determining a priority list for prioritized content to play at the streaming device;
determining a content source device connected to the streaming device based on receiving information on the content source device from the streaming device;
determining content available to the streaming device based on the content source device; and
automatically controlling the streaming device to play the prioritized content based on the priority list and the content available, including directing the streaming device to send a control signal to the content source device.

17. The memory device of claim 16, wherein:
the content source device is one of a plurality of content source devices connected to the streaming device;
the instructions, when executed, cause the processor to perform the method further comprising:
providing streaming content from the streaming service to the streaming device, wherein the streaming service comprises one of the plurality of content source devices;
determining the content available to the streaming device based on content available from each of the plurality of content source devices;
controlling the streaming device to play the prioritized content further includes directing the streaming device to:
switch to an input of a selected one of the plurality of content source devices; and
send a control signal causing the selected one of the plurality of content source devices to switch to a specified content channel.

18. The memory device of claim 16 storing instructions that, when executed, cause the processor to perform the method further comprising:
receiving a user selection of programming to add to the prioritized content; and
generating the priority list based on the user selection.

19. The memory device of claim 16 storing instructions that, when executed, cause the processor to perform the method further comprising:
automatically generating the priority list at the streaming service based on attribute information associated with the streaming device.

20. The memory device of claim 16 storing instructions that, when executed, cause the processor to perform the method further comprising:
the prioritized content playing at the streaming device includes a sporting event;
monitoring for an end of the prioritized content playing at the streaming device based on a sport score reporting service; and
dynamically changing content playing at the streaming device when the end of the prioritized content is detected.
